(19) United States
(12) Patent Application Publication
(10) Pub. No.: US 2024/0062315 A1
(43) Pub. Date: Feb. 22, 2024

(54) SYSTEM FOR EVALUATING USER DEMEANOR, AUTHENTICITY AND METHOD THEREOF

(71) Applicant: Wildr Inc., San Francisco, CA (US)

(72) Inventors: Amit Roy Sharma, Sydney (AU); Melissa Ravi, San Francisco, CA (US); Vidit Drolia, San Francisco, CA (US)

(21) Appl. No.: 18/452,760

(22) Filed: Aug. 21, 2023

Related U.S. Application Data
(60) Provisional application No. 63/400,042, filed on Aug. 22, 2022.

(51) Int. Cl. G06Q 50/00; H04L 67/50

(52) U.S. Cl. CPC G06Q 50/01; H04L 67/535

(57) ABSTRACT

A system (100) for evaluating user demeanor and authenticity comprises a profile ring feature module (102) configured to exhibit a profile ring on a profile of each user, wherein the profile ring serves as an indicator within an online social networking platform (101), a user activity tracking module (103) configured to generate one or more signals derived from a plurality of actions executed by users on the online social networking platform (101), a notification module (104) configured to provide real time notifications to the user upon detecting variations in the color of the profile ring, Further, the present invention discloses a method (200) that generates valuable data about user engagement patterns and behavior. This data is analyzed over time to derive insights into user trends, preferences, and interactions, aiding in platform improvement and strategic decision-making.

### CROSS-REFERENCE TO RELATED APPLICATIONS

This application claims priority from U.S. provisional application Ser. No. 63/400,042 filed on 22 Aug. 2022 entitled “METHODS AND SYSTEMS OF ONLINE SOCIAL NETWORKING”, the entirety of which is herein incorporated by reference.

### DESCRIPTION OF THE INVENTION

### Technical Field of the Invention

The present invention relates to a field of behavior analysis of a user in the realm of online social networking platform along with the corresponding method. Specifically, the invention pertains to a system incorporating a profile ring feature designed to dynamically represent a user's demeanor and authenticity through a visually intuitive indicator embedded within the platform's interface.

### Background of the Invention

In the realm of social networking platforms, evaluating how users engage and whether their interactions are authentic has traditionally relied on fragmented and often complex metrics such as comments received, like received and ratings assigned to their posts. However, these metrics lack the immediate and holistic representation of the user's overall behavior and the authenticity of their interactions. For instance, the likes and comments may offer a partial picture of user engagement, but they might not effectively capture the entirety of a user's behavior on the platform.

The current landscape of online social networking platforms lacks an efficient and uncomplicated means for users to promptly evaluate the authenticity and positivity of their peers. Consequently, this absence necessitates prolonged interactions and observations as prerequisites for cultivating a well-founded perception about others and further developing an informed understanding. Furthermore, when users attempt to assess the behaviour of other users on these social networking platforms, they frequently encounter challenges marked by intricacy and ambiguity. This complexity originates from the intricate interplay of various metrics that are utilized for evaluation purposes. This intricate web of metrics leads to uncertainty and hesitation when it comes to connecting and interacting with new individuals on these platforms. The users may find it difficult to ascertain the true nature of others' behaviour due to the multifaceted nature of the metrics used, causing them to feel unsure about the authenticity of their interactions. As a result, users may hesitate to establish connections with new individuals due to the potential complexity and unpredictability associated with evaluating their behaviour.

The prevailing evaluation methodologies employed on online platforms suffer from a limited perspective, often concentrating solely on a confined selection of user activities such as likes and comments. This limited approach fails to encompass the wide spectrum of interactions that collectively shape a user's comprehensive authenticity and positivity in their digital engagements.

In addition to the aforementioned limitations in evaluating user behavior and authenticity on online platforms, there is an additional challenge related to the absence of a singular visual representation that encapsulates the multifaceted dimensions of user behavior and authenticity. As a result, users often encounter the need to navigate through multiple profiles and interactions to form a holistic judgment about other users. This, in turn, requires users to invest substantial effort and time in order to formulate a comprehensive assessment of other users.

The Patent Application No. U.S. Ser. No. 10/574,781B2 titled “Profile page with biographical summary for social networking system user” relates to a pertains to a social networking system that furnishes a concise and impartial biographical summary for users. This succinct biography encompasses pertinent biographical details extracted from the user's profile, which are then showcased on the user's profile page. Alongside this brief bio, a selection of photos from the user's profile may also be presented, chosen for their contextual significance. The determination of relevance for these elements is influenced by factors including temporal context and their importance to the viewer. This arrangement of the succinct biography enables viewers to conveniently access the user's most current biographical information in an abbreviated layout.

The Patent Application No. KR101829770B1, titled “Online social persona management” pertains to a framework that employs semantic modeling techniques to portray a user's social role within online self-expression tools, including blogs and social networking platforms. This modeling approach encompasses various methods by which users engage with content, as manifested through explicit interests showcased in their profiles and within the broader social representation of the community. Distinct patterns emerge that guide users in expressing their preferences within the community. One embodiment permits users to monitor how their posts and comments influence their online behavior. Additionally, another embodiment deduces the requirements of an online community and provides suggestions, recommendations, or alerts to users.

Thus, there is a need for an innovative solution that bridges these deficiencies and facilitates the establishment of an online social environment that is characterized by informed decision-making, positivity, and meaningful engagement. These solutions significantly enhance the user experience and contribute to the evolution of a more productive and enriching landscape within the realm of online social networking.

### SUMMARY OF THE INVENTION

The present invention overcomes the drawbacks of the prior art by disclosing a system for evaluating user demeanor and authenticity. The system introduces a novel approach to enhance the quality and depth of online social interactions. By introducing the visually captivating “Profile Ring” feature, the system aims to elevate user engagement levels and foster more genuine connections among users within the online social networking environment.

The present invention further discloses a method for evaluating user demeanor and authenticity within the context of an online social networking platform. The method encompasses several steps that collectively enhance the understanding of user interactions and behaviors. The method involves the generation of signals derived from a diverse array of user actions performed on the platform, thereby forming a comprehensive data set. These signals capture nuanced aspects of user engagement and interaction. Subsequently, the method calculates a user's behavioral score by meticulously analyzing the nature and extent of their engagement activities indicated by the generated signals. This behavioral score serves as a quantifiable representation of the user's online behavior. Further, the method employs this computed behavioral score to determine the color of a profile ring associated with the user. This profile ring, acting as a visual identifier within the online social networking platform, signifies the user's distinct degrees of demeanor and authenticity. As the user behavior evolves, real-time notifications are triggered upon detecting variations in the color of the profile ring, allowing users to promptly recognize shifts in their online presence. The method provides a holistic means of assessing user interactions and behaviors, ultimately fostering a more informed, transparent, and enriched online social networking experience.

The utilization of the profile ring in an online social networking platform, prominently displayed on each user's profile, serves as a comprehensive indicator of the individual's positivity and authenticity. The present invention provides real-time feedback empowering users to be aware of shifts in their behavior within the online social network. Moreover, the profile ring's visibility to other users ensures transparency and accountability, allowing members to actively assess each other's interactions based on the indicative color changes.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram disclosing a system for evaluating user demeanor and authenticity.

FIG. 2 illustrates a flow diagram disclosing a method for evaluating user demeanor and authenticity.

### DETAILED DESCRIPTION OF THE INVENTION

Reference will now be made in detail to the description of the present subject matter, one or more examples of which are shown in figures. Each example is provided to explain the subject matter. Various changes and modifications obvious to one skilled in the art to which the invention pertains, are deemed to be within the spirit, scope and contemplation of the invention.

The terminology used in the description presented herein is not intended to be interpreted in any limited or restrictive way, simply because it is being utilized in conjunction with detailed description of certain specific embodiments of the invention. The terms “signals”, “generated signals” may be interchangeably used.

The present invention unveils a system designed to enrich the caliber and extent of interactions within online social environments. Through the introduction of the visually engaging profile ring feature, the system aspires to elevate user participation and cultivate authentic connections among individuals in the online social networking realm.

The present invention discloses a method for evaluating user demeanor and authenticity within the realm of online social networking platforms. The method encompasses a series of steps aimed at enhancing the comprehension of user interactions and behaviors. In accordance with the method, signals are generated, derived from a diverse range of user actions executed within the online social networking platform. These signals collectively form a comprehensive dataset, capturing nuanced aspects of user engagement and interactions. Subsequently, the method computes a user's behavioral score by analyzing the nature and extent of their engagement activities, as indicated by the generated signals. This behavioral score provides a quantifiable representation of the user's online conduct. The computed behavioral score is then utilized to determine the color of a profile ring associated with the user. This profile ring, functioning as a visual identifier within the online social networking platform, conveys the user's distinct levels of demeanor and authenticity. In response to evolving user behaviors, the method triggers real-time notifications upon detecting variations in the color of the profile ring. This enables users to promptly discern shifts in their online presence, thereby enhancing their awareness and engagement. The method offers a comprehensive framework for assessing user interactions and behaviors, thereby fostering an informed, transparent, and enriched online social networking experience.

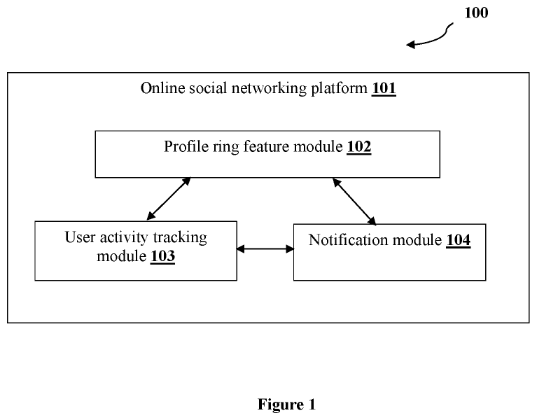

FIG. 1 illustrates a block diagram disclosing a system for evaluating user demeanor and authenticity. The system (100) for evaluating a user demeanor and authenticity within an online social networking platform (101) comprises a profile ring feature module (102) configured to exhibit a profile ring on a profile of each user, wherein the profile ring serves as an indicator within an online social networking platform (101), reflecting the user's degrees of demeanor and authenticity. Further, the system (100) comprises a user activity tracking module (103) configured to generate one or more signals derived from a plurality of actions executed by one or more users on the online social networking platform (101), wherein the signals are utilized for the computation of a user's behavioral score to determine a color of the profile ring. Furthermore, the system (100) comprises a notification module (104) configured to provide real time notifications to the user upon detecting variations in the color of the profile ring, wherein the color variations of the profile ring indicate modifications in the user's degrees of demeanor and authenticity.

In an embodiment, the user activity tracking module (103) utilizes the user's behavioral score based on the nature and extent of the user's engagement activities to determine the color of the profile ring. In an embodiment, the profile ring feature module (102) facilitates visibility of the profile ring by other users, thereby enabling the other users to make one or more informed determinations based on the color of the profile ring associated with the user.

In an embodiment, the system (100) comprises a plurality of user devices that are interconnected through a communication network and connected to the online social networking platform (101). Within this arrangement, the social networking platform (101) serves as a foundational platform, acting as a backbone through which various other systems deliver social networking services and functionalities to users over the internet.

In an embodiment, a user device may use the communication network to communicate with one or more servers. In an embodiment, the communication network may include a communication medium through which the system (100), the server, and one or more user device may communicate with each other. Examples of the communication network may include, but are not limited to, the internet, a Wireless Fidelity (Wi-Fi) network, a Personal Area Network (PAN), a Local Area Network (LAN), or a Metropolitan Area Network (MAN). In an embodiment, a user device may include a computer system such as a desktop computer, notebook or laptop computer, netbook, a tablet computer, e-book reader, Global Positioning System (GPS) device, camera, Personal Digital Assistant (PDA), handheld electronic device, cellular telephone, smartphone, augmented/virtual reality device, electronic device, or any suitable combination thereof and may also include a web browser, such as MICROSOFT INTERNET EXPLORER, GOOGLE CHROME or MOZILLA FIREFOX, and may have one or more add-ons, plug-ins, or other extensions, such as TOOLBAR.

In an embodiment, the online social networking platform (101) is enriched by the inclusion of user-generated/created content, which serves to enhance and elevate user engagements within the platform. User-generated content encompasses a wide array of contributions that users add, upload, transmit, or “post” to the online social networking platform (101). For instance, a user transmits posts to the online social networking platform (101) using a user device. These posts encapsulate diverse data types, including status updates, textual information, location data, photographs, videos, hyperlinks, musical content, and other analogous data and media forms. In one embodiment, a user creates a brief personal description/profile on the online social networking platform (101). The brief description comprises various user profile details, including personal background information. The content the user shares/generates/creates holds considerable sway over the image the user project to others. Essentially, the nature of the posts, comments, and interactions shapes the way the users are perceived by fellow community members/peers.

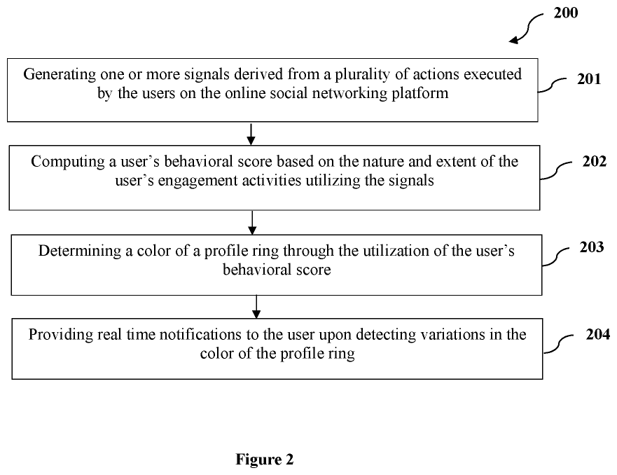

FIG. 2 illustrates a flow diagram disclosing a method for evaluating user demeanor and authenticity. The method (200) comprises the step of generating one or more signals derived from a plurality of actions executed by the users on the online social networking platform in step (201). In step (202), a user's behavioral score is computed based on the nature and extent of the user's engagement activities utilizing the signals. In step (203), a color of a profile ring is determined through the utilization of the user's behavioral score, wherein the color of the profile ring serves as an indicator within an online social networking platform, reflecting the user's degrees of demeanor and authenticity. Further, in step (204), real time notifications are provided to the user upon detecting variations in the color of the profile ring, wherein the color variations indicate modifications in the user's degrees of demeanor and authenticity.

In an embodiment, the user's engagement activities include the user's historical behavior, quality of posts, content posted, analysis of affective state, instances of being blocked by other users, and positive ratings provided by other users for determining the color of the profile ring.

There are several advantages of the present invention including assessing user behavior and engagement activities using generated signals and without being influenced by biases or subjective opinions. The method (200) offers a clear and concise measure of a user's level of activity and involvement within the online social networking platform (101). The method (200) helps in assigning colors to profile rings based on behavioral scores, thereby introducing a personalized and easily recognizable visual element. This visual cue allows users to quickly understand the demeanor and authenticity levels of their peers, contributing to a richer and more nuanced social experience. The color of the profile ring serves as a transparent indicator of a user's behavior and engagement. This transparency promotes authenticity by allowing users to gauge the reliability and credibility of other users' actions.

Further, another advantage of the method (200) is providing real-time notifications about color variations in profile rings offers immediate feedback to users, thereby enabling users to be aware of any shifts in their own or others' levels of demeanor and authenticity, promoting self-awareness and informed interactions. The method (200) encourages users to engage positively and authentically within the online social networking platform.

Yet, another advantage of the method (200) is reducing the potential for misrepresentation or manipulation of user profiles. Further, the method (200) generates valuable data about user engagement patterns and behavior. This data is analyzed over time to derive insights into user trends, preferences, and interactions, which aid in platform improvement and strategic decision-making. The method (200) collectively contributes to a more engaging, authentic, and informed social networking experience for users.

TABLE 1
Reference numbers:

| Components | Reference Numbers |
|---|---|
| System | 100 |
| Online social networking platform | 101 |
| Profile ring feature module | 102 |
| User activity tracking module | 103 |
| Notification module | 104 |

We claim:

1. A system for evaluating a user demeanor and authenticity within an online social networking platform, the system (100) comprises:
a. a profile ring feature module (102) configured to exhibit a profile ring on a profile of each user, wherein the profile ring serves as an indicator within an online social networking platform (101), reflecting the user's degrees of demeanor and authenticity;
b. a user activity tracking module (103) configured to generate one or more signals derived from a plurality of actions executed by one or more users on the online social networking platform (101), wherein the signals are utilized for the computation of a user's behavioral score to determine a color of the profile ring; and
c. a notification module (104) configured to provide plurality of real time notifications to the user upon detecting variations in the color of the profile ring, wherein the color variations of the profile ring indicate modifications in the user's degrees of demeanor and authenticity.

2. The system (100) as claimed in claim 1, wherein the user activity tracking module (103) utilizes the user's behavioral score based on the nature and extent of the user's engagement activities to determine the color of the profile ring.

3. The system (100) as claimed in claim 1, wherein the profile ring feature module (102) facilitates visibility of the profile ring by other users, thereby enabling the other users to make one or more informed determinations based on the color of the profile ring associated with the user.

4. A method for evaluating a user demeanor and authenticity within an online social networking platform, the method (200) comprising the steps of:
a. generating one or more signals derived from a plurality of actions executed by the users on the online social networking platform (201);
b. computing a user's behavioral score based on the nature and extent of the user's engagement activities utilizing the signals (202);
c. determining a color of a profile ring through the utilization of the user's behavioral score, wherein the color of the profile ring serves as an indicator within an online social networking platform, reflecting the user's degrees of demeanor and authenticity (203); and
d. providing real time notifications to the user upon detecting variations in the color of the profile ring, wherein the color variations indicate modifications in the user's degrees of demeanor and authenticity (204).

5. The method (200) as claimed in claim 4, wherein the user's engagement activities include the user's historical behavior, quality of posts, content posted, analysis of affective state, instances of being blocked by other users, and positive ratings provided by other users for determining the color of the profile ring.
